(19) United States
(12) Patent Application Publication
(10) Pub. No.: US 2021/0127226 A1
(43) Pub. Date: Apr. 29, 2021

(54) EMERGENCY ALERT SYSTEMS WITH PERIMETER MONITORING

(71) Applicant: In-telligent Properties LLC, Chicago, IL (US)

(72) Inventor: Allan C. Sutherland, Orland Park, IL (US)

(21) Appl. No.: 17/072,267

(22) Filed: Oct. 16, 2020

Related U.S. Application Data
(60) Provisional application No. 62/927,494, filed on Oct. 29, 2019.

(51) Int. Cl. H04W 4/021; H04W 4/029; G08B 13/196; G08B 21/04

(52) U.S. Cl. CPC H04W 4/021; G08B 21/0469; G08B 13/1961; H04W 4/029

(57) ABSTRACT

Aspects discussed herein relate to monitoring a perimeter of a geographic area and generating alerts when a breach of the perimeter is detected. When there is a breach in a perimeter or border there are two major problems authorities generally experience. First, problems exist regarding tracking the intruder and determining if the user has actually breached the perimeter. Second, problems exist identifying and sending the closest resources to address the issue. Systems and methods described herein can identify and track intruders crossing a border or perimeter, then creating an alerting area within proximity of the intruder and sending alerts to resources within the alerting area. This is ideal when resources are limited or stretched thin. The alerts can override any alert-inhibiting state of the mobile device to deliver audio, visual, and/or haptic notifications.

### CROSS-REFERENCE TO RELATED APPLICATIONS

The instant application claims priority to U.S. Provisional Patent Application No. 62/927,494, titled “Perimeter Monitoring Systems” and filed Oct. 29, 2019, the disclosure of which is hereby incorporated by reference in its entirety.

### FIELD OF USE

Aspects of the disclosure relate generally to communication systems and more specifically to important and emergency alert systems.

### BACKGROUND

People use many different systems to send and receive messages with others, including individual emails, group emails, texts to mobile devices, etc. during emergency and time-sensitive events. Existing emergency alert systems like the Federal Emergency Alert System rely on people listening to a radio, television, or similar device to receive their alerts. These devices may interfere with sleep and therefore are usually turned off while people are sleeping or otherwise busy. The precision in which emergency alert systems use for transmitting alerts is further limited to existing telecommunication architecture. For example, if there were a fire in a portion of Orange County, Calif., the existing emergency alerts systems would notify the entire Los Angeles metropolitan area and portions of the surrounding counties. Alert systems utilizing mobile phones are similarly limited as they do not allow emergency alerts to be audibly provided while the mobile phone is in a silent or do not disturb mode.

Aspects described herein may address these and other problems, and generally improve the quality, efficiency, and speed of emergency alerts by improving the ability of a system to quickly and easily identify groups of people such that these people may be quickly contacted in the event of a determined condition.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Aspects discussed herein relate to monitoring a perimeter of a geographic area and generating alerts when a breach of the perimeter is detected. When there is a breach in a perimeter or border there are two major problems authorities generally experience. First, problems exist regarding tracking the intruder and determining if the user has actually breached the perimeter. Second, problems exist identifying and sending the closest resources to address the issue. Systems and methods described herein can identify and track intruders crossing a border or perimeter, then creating an alerting area within proximity of the intruder and sending alerts to resources within the alerting area. This is ideal when resources are limited or stretched thin. The alerts can override any alert-inhibiting state of the mobile device to deliver audio, visual, and/or haptic notifications.

In one embodiment, a computer-implemented method includes obtaining an indication of an intruder in a first detection zone, determining a current location of the intruder, determining a direction of travel of the intruder, generating an alert area including a geographic location in the direction of travel of the intruder, identifying at least one user associated with the alert area, generating an alert indicating the current location of the intruder, the direction of travel of the intruder, the alert area, and at least one notification, and transmitting the alert to at least one computing device associated with the at least one user, wherein the alert causes a computing device to provide the at least one notification irrespective of any alert-inhibiting state of the computing device.

In yet another embodiment of the invention, the computer-implemented method further includes determining the direction of travel of the intruder by obtaining an indication of the intruder in a second detection zone distinct from the first detection zone, determining a relative location of the second detection zone to the first detection zone, and determining the direction of travel based on the relative location of the second detection zone to the first detection zone.

In still another embodiment of the invention, the computer-implemented method further includes obtaining a first time when the intruder is located in the first detection zone, obtaining a second time when the intruder is located in the second detection zone, calculating an elapsed time based on a difference between the second time and the first time, calculating a distance traveled based on a size of the first detection zone and a size of the second detection zone, calculating a speed of the intruder based on the elapsed time and the distance traveled, and including the calculated speed in the generated alert.

In yet still another embodiment of the invention, the computer-implemented method further includes generating the alert area based on the calculated speed.

In yet another additional embodiment of the invention, the computer-implemented method further includes obtaining an indication that the intruder has entered a second detection zone, wherein the first detection zone is located before a border and the second detection zone is located beyond the border, generating a second alert to a community of users associated with the border, and transmitting the second alert to at least one computing device associated with the community of users associated with the border.

In still another additional embodiment of the invention, the indication that the intruder is located in the first detection zone includes sensor data captured using at least one sensor selected from the group consisting of cameras, motion detectors, pressure sensors, microphones, and infrared sensors.

In yet still another additional embodiment of the invention, the at least one notification is selected from the group consisting of an audible notification, a visual notification, and a haptic notification.

Yet another embodiment of the invention includes a computing device including a processor and a memory in communication with the processor and storing instructions that, when read by the processor, cause the computing device to obtain an indication of an intruder in a first detection zone, determine a current location of the intruder, determine a direction of travel of the intruder, generate an alert area including a geographic location in the direction of travel of the intruder, identify at least one user associated with the alert area, generate an alert indicating the current location of the intruder, the direction of travel of the intruder, the alert area, and at least one notification, and transmit the alert to at least one computing device associated with the at least one user, wherein the alert causes a computing device to provide the at least one notification irrespective of any alert-inhibiting state of the computing device.

In yet another embodiment of the invention, the instructions, when read by the processor, further cause the computing device to determine the direction of travel of the intruder by obtaining an indication of the intruder in a second detection zone distinct from the first detection zone, determining a relative location of the second detection zone to the first detection zone, and determining the direction of travel based on the relative location of the second detection zone to the first detection zone.

In still another embodiment of the invention, the instructions, when read by the processor, further cause the computing device to obtain a first time when the intruder is located in the first detection zone, obtain a second time when the intruder is located in the second detection zone, calculate an elapsed time based on a difference between the second time and the first time, calculate a distance traveled based on a size of the first detection zone and a size of the second detection zone, calculate a speed of the intruder based on the elapsed time and the distance traveled, and include the calculated speed in the generated alert.

In yet still another embodiment of the invention, the instructions, when read by the processor, further cause the computing device to generate the alert area based on the calculated speed.

In yet another additional embodiment of the invention, the instructions, when read by the processor, further cause the computing device to obtain an indication that the intruder has entered a second detection zone, wherein the first detection zone is located before a border and the second detection zone is located beyond the border, generate a second alert to a community of users associated with the border, and transmit the second alert to at least one computing device associated with the community of users associated with the border.

In still another additional embodiment of the invention, the indication that the intruder is located in the first detection zone includes sensor data captured using at least one sensor selected from the group consisting of cameras, motion detectors, pressure sensors, microphones, and infrared sensors.

In yet still another additional embodiment of the invention, the at least one notification is selected from the group consisting of an audible notification, a visual notification, and a haptic notification.

Still another embodiment of the invention includes a non-transitory machine-readable medium storing instructions that, when executed by one or more processors, cause the one or more processors to perform steps including obtaining an indication of an intruder in a first detection zone, determining a current location of the intruder, determining a direction of travel of the intruder, generating an alert area including a geographic location in the direction of travel of the intruder, identifying at least one user associated with the alert area, generating an alert indicating the current location of the intruder, the direction of travel of the intruder, the alert area, and at least one notification, and transmitting the alert to at least one computing device associated with the at least one user, wherein the alert causes a computing device to provide the at least one notification irrespective of any alert-inhibiting state of the computing device.

In yet another embodiment of the invention, the instructions, when executed by one or more processors, further cause the one or more processors to determine the direction of travel of the intruder by performing steps including obtaining an indication of the intruder in a second detection zone distinct from the first detection zone, determining a relative location of the second detection zone to the first detection zone, and determining the direction of travel based on the relative location of the second detection zone to the first detection zone.

In still another embodiment of the invention, the instructions, when executed by one or more processors, further cause the one or more processors to perform steps including obtaining a first time when the intruder is located in the first detection zone, obtaining a second time when the intruder is located in the second detection zone, calculating an elapsed time based on a difference between the second time and the first time, calculating a distance traveled based on a size of the first detection zone and a size of the second detection zone, calculating a speed of the intruder based on the elapsed time and the distance traveled, and including the calculated speed in the generated alert.

In yet still another embodiment of the invention, the instructions, when executed by one or more processors, further cause the one or more processors to perform steps including obtaining an indication that the intruder has entered a second detection zone, wherein the first detection zone is located before a border and the second detection zone is located beyond the border, generating a second alert to a community of users associated with the border, and transmitting the second alert to at least one computing device associated with the community of users associated with the border.

In yet another additional embodiment of the invention, the indication that the intruder is located in the first detection zone includes sensor data captured using at least one sensor selected from the group consisting of cameras, motion detectors, pressure sensors, microphones, and infrared sensors.

In still another additional embodiment of the invention, the at least one notification is selected from the group consisting of an audible notification, a visual notification, and a haptic notification.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates an example of an emergency alert system in which one or more aspects described herein may be implemented;

FIG. 2 illustrates an example computing device in accordance with one or more aspects described herein;

FIG. 3 depicts a flow chart for providing an emergency alert in accordance with one or more aspects described herein;

FIG. 4 depicts a flow chart for perimeter detection according to one or more aspects of the disclosure;

FIG. 5 depicts a flow chart for determining an intruder direction according to one or more aspects of the disclosure;

FIG. 6 depicts a flow chart for providing alerts according to one or more aspects of the disclosure;

FIG. 7 depicts a perimeter database according to one or more aspects of the disclosure;

FIG. 8 depicts an intruder database according to one or more aspects of the disclosure;

FIG. 9 is a conceptual illustration of a detection zone according to one or more aspects of the disclosure;

FIG. 10 illustrates a process for providing an emergency alert in accordance with one or more aspects described herein; and

FIG. 11 depicts a flow chart for cross routing of alerts according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

Emergency alert systems may override any alert-inhibiting state in a person's mobile device to deliver an audible, visual, and/or haptic alert in an emergency, such when a breach of a perimeter of a geographic area is detected. When there is a breach in a perimeter or border there are two major problems authorities generally experience. First, problems exist regarding tracking the intruder and determining if the user has actually breached the perimeter. Second, problems exist identifying and sending the closest resources to address the issue. Systems and methods described herein can identify and track intruders crossing a border or perimeter, then creating an alerting area within proximity of the intruder and sending alerts to resources within the alerting area. This is ideal when resources are limited or stretched thin. The alerts can override any alert-inhibiting state of the mobile device to deliver audio, visual, and/or haptic notifications.

Emergency alert systems provide a method of communicating with members of a community by using geofencing to determine the location of users such that they may optionally be automatically added to a community. Members may be auto-subscribed into the community based on their physical locations. These subscriptions may change from time to time as the mobile device moves. Users may also be added to a community based on their own user preferences. People may be members of more than one community and the communities may change over time. A variety of systems and methods for establishing the location of a mobile device and providing alerts to the mobile device in accordance with embodiments of the invention are described in U.S. Pat. No. 10,251,023, titled “Notification and Communication System using Geofencing to Identify Members of a Community” and issued Apr. 2, 2019, the disclosure of which is hereby incorporated by reference in its entirety.

For example, emergency alert systems in accordance with embodiments of the invention can communicate with members of a community by using geofencing to determine the location of users such that they can optionally be automatically added to a community. As such, members may be auto-subscribed into the community based on their physical locations (which may change from time to time). Members or users can also be added to the community based on their own user preferences. People can be members of more than one community and the communities can change over time. Geofencing systems can be used to determine whether a particular mobile device is physically present in a geographic region or area or range (for example, in a building or on a property) based upon the physical location of the smartphone. If the user's phone is determined to be on the property, the user's phone can be automatically added to the property community. In cases where the mobile device is determined not to be physically present on the property (e.g. not detected by proximity sensors in the location), the user can be provided with the option of voluntarily subscribing to join the community. In this way, interested users (e.g.: building tenants who are away at work, or persons working at different jobsites) can be kept informed of developments and alerts with regard to a particular property community even when they are physically away from that property.

Emergency alert systems determine the “alert state” of each of the individuals' smart devices. This can be accomplished by sending a signal to the user's mobile device to determine if the “silent” or “do not disturb” setting is on. If the mobile device setting is alert-enabled (e.g. the “do not disturb” or “silent” function is not turned on), then the mobile device is ready to receive alert messages at step 210. However, in those cases where the mobile device is not alert-enabled (e.g. the “do not disturb” or “silent” function is turned on), then one of two options is possible. First, the user can be sent a message asking if the alert setting can be switched to alert-enabled. Should the user agree and grant permission, then the alert enabled setting is enabled (e.g. the “do not disturb” or “silent” function is overridden). Alternatively, the present system may instead automatically override the “do not disturb” or “silent” function, thereby enabling the mobile device to receive alerts and communications from the emergency alert system irrespective of the “do not disturb” or “silent” function. As such, an important advantage of the present system is that it can be prioritized over typical email, text, and notification traffic, even when the user's phone is set on silent, and warn building or property occupants in the event of an emergency situation such as a fire, crime, or medical emergency.

In addition to sending emergency alerts, emergency alert systems can send property-specific (and/or interest group-specific) messages and non-property-specific messages (e.g. messages appealing to more than one property or interest group-specific group). The property-specific messages and the non-property-specific messages may be sent with the smartphone's “do not disturb” or “silent” function overridden and turned off. However, the more likely desired setting may be having the property-specific messages and non-property-specific messages subject to the smartphone's “do not disturb” or “silent” settings. Emergency alert systems can be configured such that only emergency messages will override the smartphone's “do not disturb” or “silent” settings while other messages (e.g.: building advertisements/messages) will not override the smartphone's “do not disturb” or “silent” settings. The settings used can optionally be set by members of the community themselves, either by the manager or administrator of the community, or both. This is desirable such that users/community members receive emergency alerts such as “fire” or “active shooter in the building” without such messages being silenced, but are able to block, silence, or turn off messages like “lunch specials in the building's cafe.” In preferred aspects, such advertising may be targeted and, for example, by being tailored to businesses within a 2 to 3 block radius around building. Moreover, when the user/community member first registers with the present system, they can be asked a series of questions to better target the advertising to their desires in addition to their location.

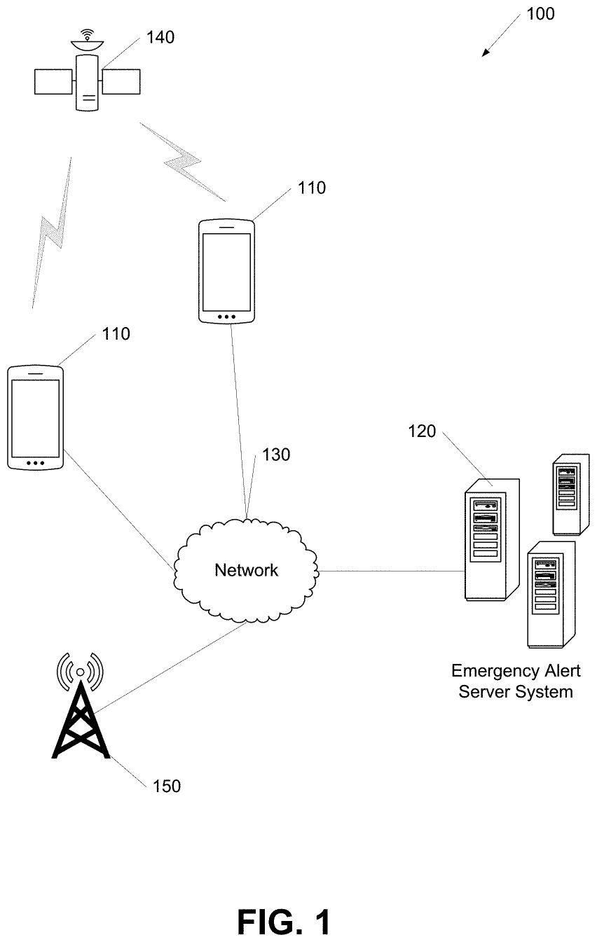

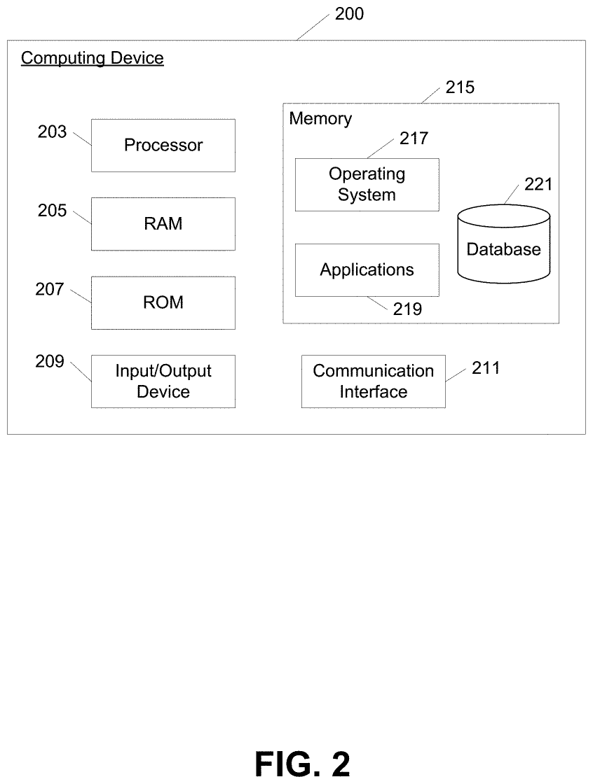

FIG. 1 illustrates an emergency alert system 100 in accordance with an embodiment of the invention. The emergency alert system 100 includes at least one client device 110 and/or at least one emergency alert server system 120 in communication via a network 130. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing devices described with respect to FIG. 2.

Client devices 110 may provide data to and/or obtain data from the at least one emergency alert server system 120 as described herein. The client devices may determine their geographic location using a variety of location-determination techniques, including receiving positioning signals from positioning system satellites 140, cellular tower triangulation, WiFi positioning systems, geocoding systems, virtual border transmitters 150, and the like. Emergency alert server systems 120 may store and process a variety of data as described herein. The network 130 may include a local area network (LAN), a wide area network (WAN), a wireless telecommunications network, and/or any other communication network or combination thereof.

The emergency alert system may also include a variety of virtual border transmitters 150. Virtual border transmitters may broadcast a signal that is capable of determining when an object, such as a person, mobile device, vehicle, and the like, enters or crosses a particular geographic location. The virtual border transmitter may be able to determine its own location via a variety of technologies, such as via GPS, and/or be pre-programmed to know its location. In this way, the virtual border transmitter may be used to create a virtual fence around a particular geographic area. In several embodiments, a number of virtual border transmitters are installed in a specific geographic region to create a virtual border around a particular geographic region. In many embodiments, a virtual border transmitter is installed in a vehicle (or other moving object) that may detect movement in an area surrounding the vehicle. In this way, specific geofenced areas may be created, either in fixed locations or in moving locations.

Some or all of the data described herein may be stored using any of a variety of data storage mechanisms, such as databases. These databases may include, but are not limited to relational databases, hierarchical databases, distributed databases, in-memory databases, flat file databases, XML databases, NoSQL databases, graph databases, and/or a combination thereof. The data transferred to and from various computing devices in the emergency alert system 100 may include secure and sensitive data, such as confidential documents, customer personally identifiable information, and account data. It may be desirable to protect transmissions of such data using secure network protocols and encryption and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the emergency alert system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in the emergency alert system 100 in front of one or more computing devices such that any external devices may communicate directly with the specialized hardware.

Turning now to FIG. 2, a computing device 200 in accordance with an embodiment of the invention is shown. The computing device 200 may include a processor 203 for controlling overall operation of the computing device 200 and its associated components, including RAM 205, ROM 207, input/output device 209, communication interface 211, and/or memory 215. A data bus may interconnect processor(s) 203, RAM 205, ROM 207, memory 215, I/O device 209, and/or communication interface 211. In some embodiments, computing device 200 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 209 may include a microphone, keypad, touch screen, and/or stylus through which a user of the computing device 200 may provide input, and may also include one or more of a speaker for providing audio output and a video display device for providing textual, audiovisual, and/or graphical output. Communication interface 211 may include one or more transceivers, digital signal processors, and/or additional circuitry and software for communicating via any network, wired or wireless, using any protocol as described herein. Software may be stored within memory 215 to provide instructions to processor 203 allowing computing device 200 to perform various actions. For example, memory 215 may store software used by the computing device 200, such as an operating system 217, application programs 219, and/or an associated internal database 221. The various hardware memory units in memory 215 may include volatile and nonvolatile, removable and non-removable media implemented in any method or technology for storage of information such as computer-readable instructions, data structures, program modules, or other data. Memory 215 may include one or more physical persistent memory devices and/or one or more non-persistent memory devices. Memory 215 may include, but is not limited to, random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Processor 203 may include a single central processing unit (CPU), which may be a single-core or multi-core processor, or may include multiple CPUs. Processor(s) 203 and associated components may allow the computing device 200 to execute a series of computer-readable instructions to perform some or all of the processes described herein. Although not shown in FIG. 2, various elements within memory 215 or other components in computing device 200, may include one or more caches, for example, CPU caches used by the processor 203, page caches used by the operating system 217, disk caches of a hard drive, and/or database caches used to cache content from database 221. For embodiments including a CPU cache, the CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the invention.

Emergency alert systems can monitor sensors (e.g. virtual border transmitters) that are arranged along a perimeter or border for intruders or movement. If an intruder is detected in a particular zone of the perimeter, the intruder can be further tracked. The direction of travel of the intruder can be determined by tracking the zones in which the intruder is detected. The speed at which the intruder is moving can be determined based on the size of the zones and the time it takes the intruder to travel between zones. For example, if the intruder is moving parallel to the perimeter or border, the intruder will trip sensors in adjacent detection areas and the emergency alert system can determine the direction of the intruder based on the data obtained from the sensors. If an intruder moves across the perimeter, the direction of the intruder can be determined based on the next detection zone(s) that they enter. The location, direction, and/or speed of the intruder can be used to generate an alert indicating the perimeter breach. For example, an alert can be generated when an intruder crosses beyond a first level of concentric detection zones and is within the perimeter or border. An alert area can be determined based on the location of the detection zones the intruder is in and the direction they are traveling. The alert area can be created within a proximity of the zone the intruder is in or moving towards. The generated alerts can be provided to a variety of devices located within the alert zone to notify those users that an intruder is heading in their direction. If no resources are within the alert zone, the zone can be expanded until resources are available.

A perimeter database can store data related to all of the perimeter or border detection zones. The perimeter database can contain locations of each detection zone, the type of sensor within the zone, and/or the diameter or area in which the detection zone covers. The perimeter database may also store which detection zones are adjacent to a detection zone. An intruder database can contain data about any detected intruder and/or which zone they were detected when the intruder was detected. The direction of the intruder can also be stored in the intruder database.

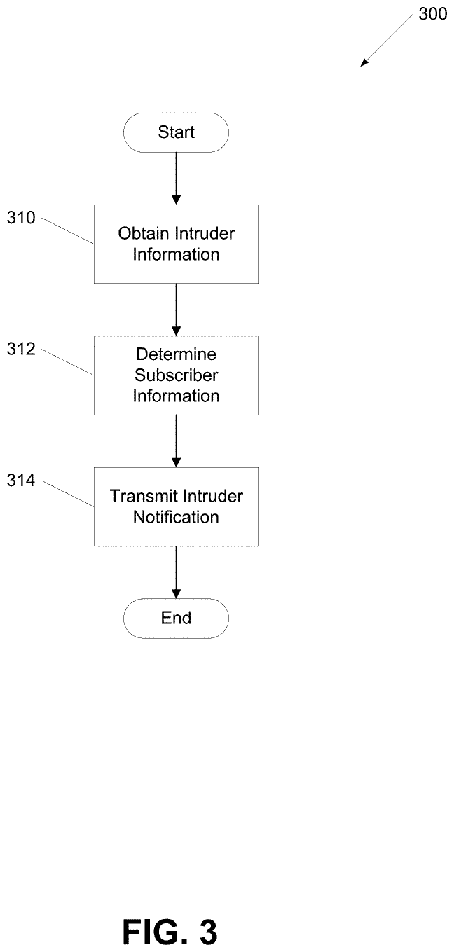

FIG. 3 depicts a flow chart for providing an emergency alert in accordance with one or more aspects described herein. Some or all of the steps of process 300 may be performed using any of the computing devices and/or combination thereof described herein. In a variety of embodiments, some or all of the steps described below may be combined and/or divided into sub-steps as appropriate.

At step 310, an emergency alert server system can obtain information from the indicating the direction and/or location of an intruder. The information can include sensor data obtained using one or more sensors located in a geographic area indicating a perimeter or border. The sensors can include, but are not limited to, cameras, motion detectors, pressure sensors, microphones, infrared sensors, RADAR and LIDAR sensors, and the like. At step 312, the emergency alert server system can determine one or more subscribers. The one or more subscribers can be located in the geographic area in which the intruder was detected and/or an alert area generated based on the location of the intruder, the direction of travel of the intruder, and/or the speed at which the intruder is traveling. At step 314, the emergency alert server system can generate an alert indicating the intruder, the direction the intruder is traveling, the speed at which the intruder is traveling, and the like. The alert can also include one or more notifications, such as audible notifications, visual notifications, and/or haptic notifications. The emergency alert server system can transmit the alert to the computing device(s) associated with the identified subscribers. The alert can cause a computing device to display the one or more notifications by overriding any alert-inhibiting state of the computing device as described herein.

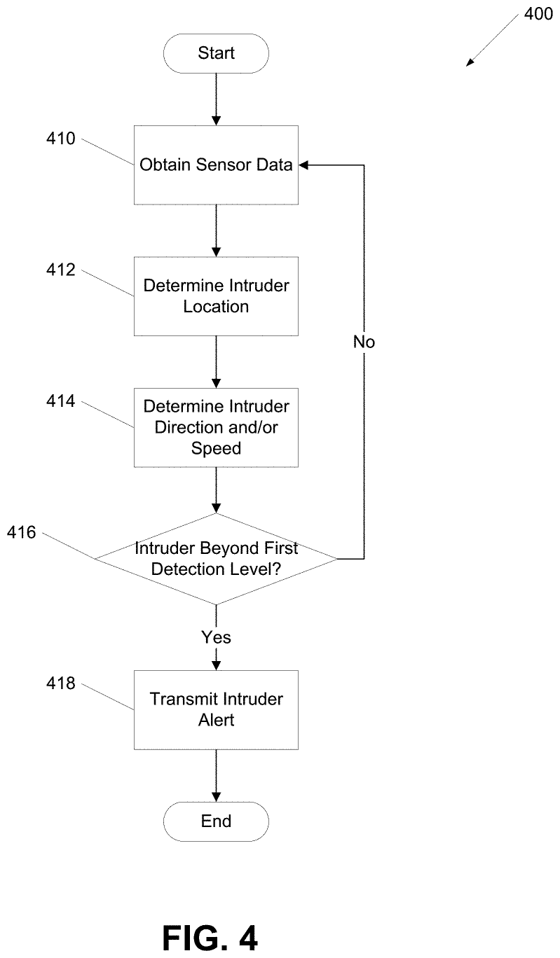

FIG. 4 depicts a flow chart for perimeter detection according to one or more aspects of the disclosure. Some or all of the steps of process 400 may be performed using any of the computing devices and/or combination thereof described herein. In a variety of embodiments, some or all of the steps described below may be combined and/or divided into sub-steps as appropriate.

At step 410, an emergency alert server system can obtain data from one or more sensors monitoring one or more detection zones along a perimeter or border. The detection zones can be arranged in adjacent consecutive zones arranged in layers along a perimeter or border. The sensor data can indicate the presence and/or location of an intruder located within the detection zone. In several embodiments, the sensor data includes a photograph and/or description of the intruder. For example, a camera can capture video of an intruder and a variety of image processing techniques, such as object detection and/or classification algorithms, can be used to process the video to identify the intruder and one or more characteristics of the intruder. These characteristics can include, but are not limited to, height, weight, gender, hair length, approximate age, skin color, clothing, identifying markings such as tattoos and/or jewelry, and the like. At step 412, the emergency alert server system can determine the location of the intruder. The location of the intruder can be determined as a geographic coordinate and/or be estimated based on the geographic location of the detection zone in which the intruder is located as appropriate. At step 414, the direction and/or speed of the intruder can be determined. The direction and/or speed of the intruder can be determined based on direction and/or speed information indicated in the sensor data and/or calculated based on one or more detection zones in which the intruder has been detected. For example, if the detection zones are 50 meters square and it takes the intruder 1 minute to travel from a first detection zone to a second detection zone, then the speed of the intruder can be calculated as 0.83 meters/second. If the second detection zone is located to the north of the first detection zone, the intruder can be determined to be traveling north. Similarly, if the second detection zone is located southwest of the first detection zone, the intruder can be determined to be traveling southwest.

At step 416, the emergency alert server system can determine if the intruder has traveled beyond a first detection level. For example, if the detected intruder is moving parallel to the perimeter or border, there is no need to generate an alert as the intruder has not actually crossed over the perimeter or border. If the intruder has not crossed the perimeter, the process can return to step 410. If the intruder crosses over the perimeter or border, the process can proceed to step 418. At step 418, the emergency alert server system can identify one or more users to alert as described herein. The emergency alert server system can generate an alert indicating the location of the intruder, the direction and/or speed of the intruder, and/or any other information as appropriate. The emergency alert server system can transmit the alert to one or more computing devices as described herein.

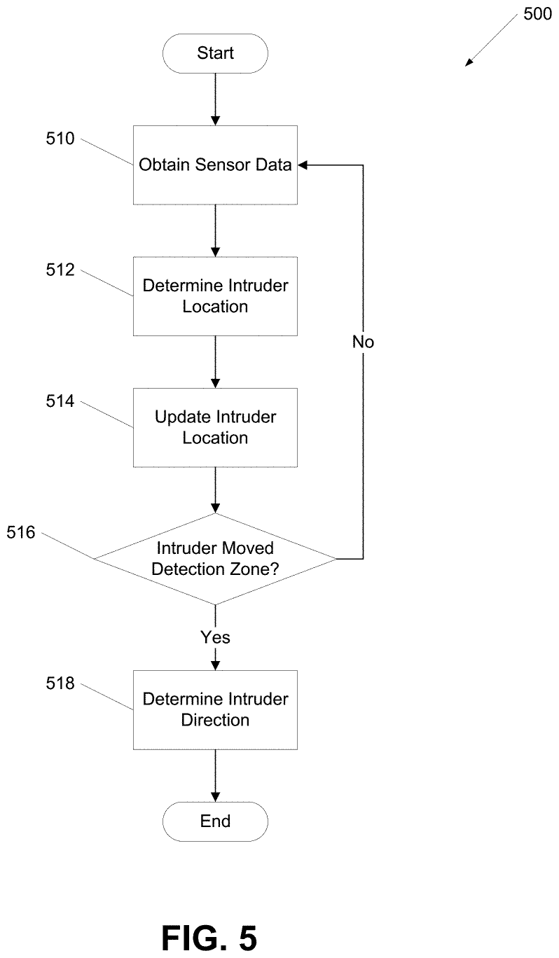

FIG. 5 depicts a flow chart for determining an intruder direction according to one or more aspects of the disclosure. Some or all of the steps of process 500 may be performed using any of the computing devices and/or combination thereof described herein. In a variety of embodiments, some or all of the steps described below may be combined and/or divided into sub-steps as appropriate.

At step 510, an emergency alert server system can obtain sensor data from one or more sensors located in one or more detection zones. The sensor data can indicate if an intruder has been detected and a detection zone in which the intruder has been detected. The emergency alert server system and query an intruder database to determine if the intruder has already been logged in the database and/or has previously been detected. When the intruder has not been previously detected, an intruder identifier can be generated for the intruder. At step 512, the location of the intruder can be determined. The intruder location can be determined directly based on the sensor data and/or estimated based on the geographic location of the sensors and/or detection zone as appropriate. At step 514, the emergency alert server system can update the intruder location. In several embodiments, the intruder location is updated by storing the determined intruder location and intruder identifier in the intruder database.

At step 516, the emergency alert server system can determine if the intruder has moved between detection zones. In many embodiments, the movement of the intruder can be determined based on the current intruder location and one or more historical locations of the intruder obtained from the intruder database. If the intruder has not moved detection zones, the process can return to step 510. If the current location differs from one or more of the historical locations, the process can proceed to step 518. At step 518, the emergency alert server system can determine that the intruder has moved and the direction in which the intruder is moving based on the geographic location of the current detection zone and the historical locations (e.g. historical detection zones). In a number of embodiments, the time at which the current location was determined can be compared to the time at which the intruder was in one or more of the historical detection zones. The speed of the intruder can be determined based on the differences in time and/or the size of the detection zones. Depending on how many levels or layers of detection zones in a perimeter monitory system, the emergency alert server system can continuously calculate and update the direction of an intruder through each layer of detection zones.

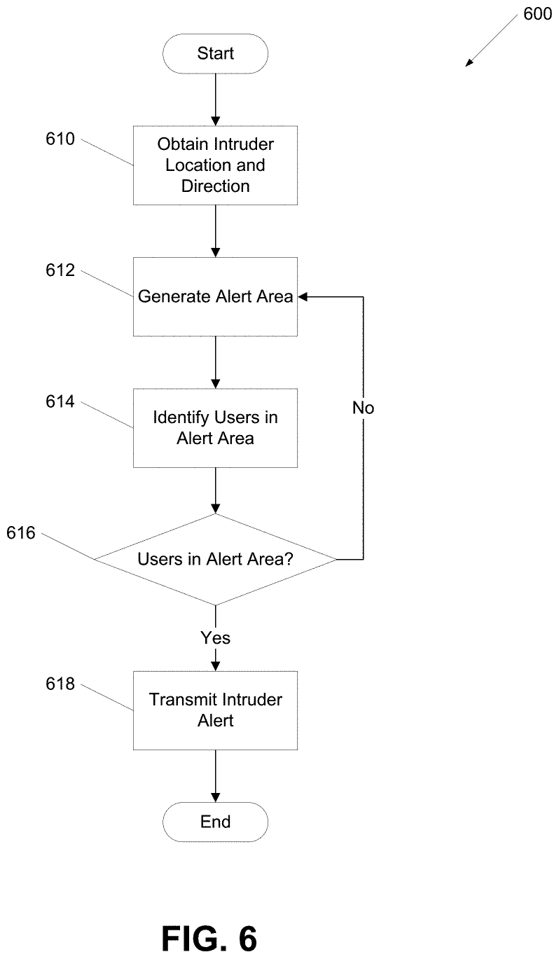

FIG. 6 depicts a flow chart for providing alerts according to one or more aspects of the disclosure. Some or all of the steps of process 600 may be performed using any of the computing devices and/or combination thereof described herein. In a variety of embodiments, some or all of the steps described below may be combined and/or divided into sub-steps as appropriate.

At step 610, an emergency alert server system can obtain information regarding an intruder. In several embodiments, the emergency alert server system can query an intruder database for location, direction, and/or speed information of an intruder. In many embodiments, the emergency alert server system can determine the location, direction, and/or speed of the intruder using sensor data obtained as described herein. At step 612, the emergency alert server system can determine an alert area. The alert area can include a geographic area and/or detection zone in which the intruder is expected to be located at a future time. The alert area can be determined based on the current location, direction, and/or speed of the intruder. The size of the alert area can be pre-determined and/or determined dynamically. For example, a pre-programmed alert area can include an alert area determined based on per set parameters such as, but not limited to, the size of the alert area, shape, and location based on intruder or detection zone proximity. A dynamically determined alert area can be determined based on the intruder location along with the intruder's direction and/or speed. For example, if an intruder is moving at a higher speed it would not make sense to create an alert area near the intrusion point, but to rather more the alert area further inward so that alerted user can respond in time before the intruder as already passed them. The size and shape of the alert area can be determined based on the location, direction, and/or speed of the intruder. For example, the shape of the alert area can be based on geographic locations that the intruder could reach within 5 minutes of the intruder's current location based on the intruder's current direction and speed of travel.

At step 614, the emergency alert server system can determine one or more users located within the alert area. The users can be determined by identifying one or more computing devices associated with the users that are determined to be within the geographic area defined by the alert area. The location of the computing devices can be determined using a variety of techniques as described herein. In several embodiments, the users belong to one or more communities. At step 616, the emergency alert server system can determine if any users are present in the alert area. If no users are present in the alert area, the process can return to step 612 to broaden the alert area until users are found at step 614. The alert area may expand based on a pre-determined radius or can dynamically expand or change based on any number of rules or data. For example, the emergency alert server system can consider geographical information and road data. If, for some reason, the alert area is not accessible from one direction, the alert area may not expand symmetrically as it would be a waste of time if it alerted a user who could not access the alert area easily. If users are present at step 616, the process can proceed to step 618. At step 618, the emergency alert server system can generate and transmit an alert to the computing device(s) associated with the users as described herein. In many embodiments, the emergency alert server system transmits the alert to one or more subscribers of the identified community and/or related communities as appropriate.

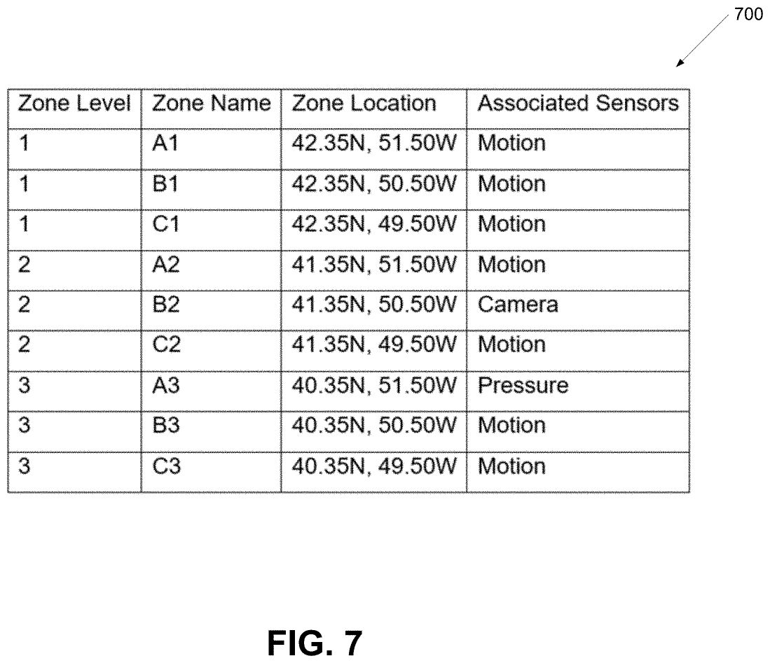

FIG. 7 depicts a perimeter database according to one or more aspects of the disclosure. The perimeter database 700 contains data related to all of the perimeter or border detection zones. It may contain locations of each detection zone, the type of sensor(s) within the zone, and/or the diameter or area in which the detection zone covers. The area of the detection zone can be indicated by a central point and a radius and/or a set of coordinates defining the perimeter as appropriate. The perimeter database may also store which detection zones are adjacent to a detection zone.

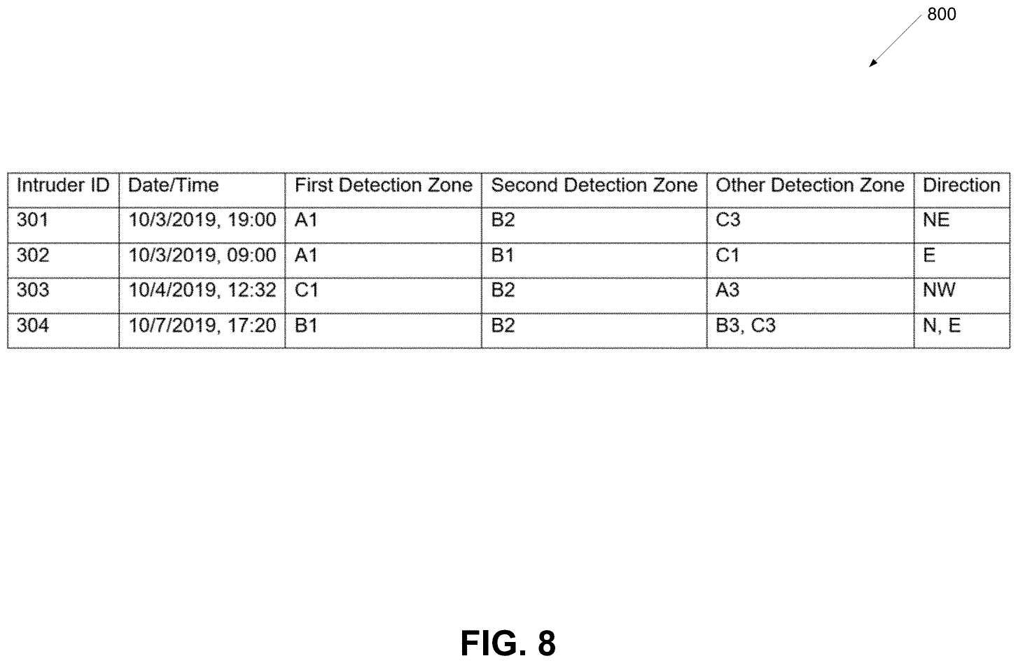

FIG. 8 depicts an intruder database according to one or more aspects of the disclosure. The intruder database 800 contains data about detected intruders, which zone(s) in which the intruders have been detected, and/or the time at which the intruder was detected. In several embodiments, the intruder database stores the calculated direction of travel and/or speed of the intruder.

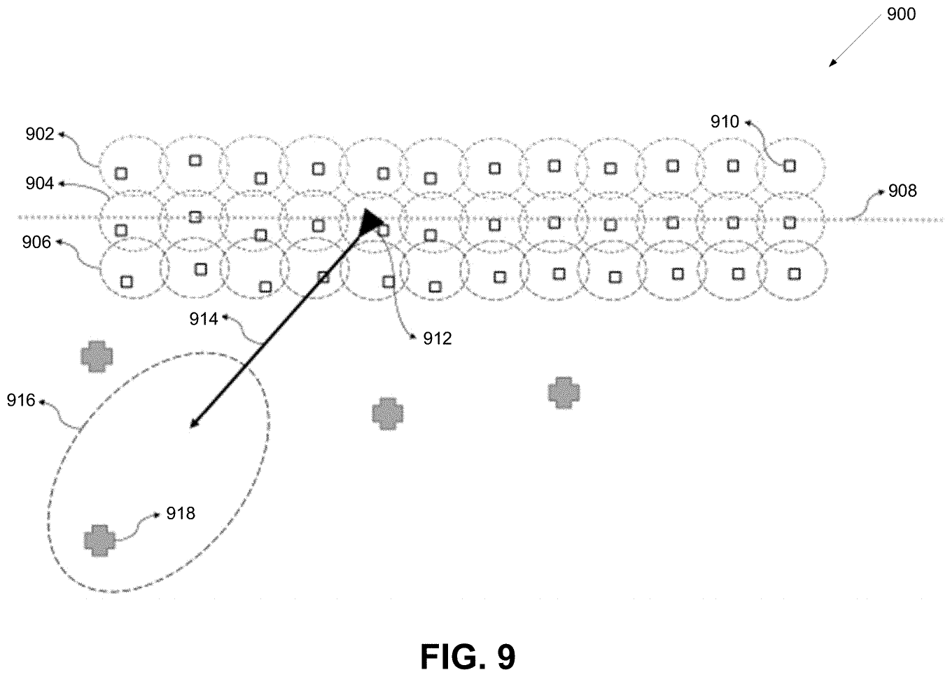

FIG. 9 is a conceptual illustration of a detection zone according to one or more aspects of the disclosure. The detection zone 900 includes a first level of consecutive and adjacent detection zones 902, a second level of consecutive and adjacent detection 904, a third level of consecutive and adjacent detection zones 906, and a perimeter or border 908. Detection zone 900 further includes sensors 910. Detection zone 900 includes three levels of detection zones arranged in consecutive and adjacent levels along the perimeter or border. However, it should be noted that any number and/or arrangement of detection zones can be used as appropriate.

Intruder 912 is crossing the perimeter 908 in a direction 914. The direction 914 can be calculated by comparing the intruder's movements from the first level of detection zones 902 into the second level of detection zones 904 as described herein. An alert area 916 is created based on the calculated direction 914 of the intruder 912. Alert area 916 includes user 918. The computing device(s) associated with user 918 can be provided with one or more alerts indicating the intruder, the alert area, and/or the expected time of arrival of the intruder into the alert area as described herein. In several embodiments, a community level alert and/or alert not specifically related to the location can be sent to all or select users of the community (and/or related communities) associated with the alert area, detection zone, and/or user 918. In many embodiments, an alert can be generated and provided to particular users and/or communities when intruders have been detected but a direction had not been calculated and/or if the intruder has not crossed the perimeter or border but is moving parallel to it. For example, a supervisor subgroup of a community may receive alerts for potential intruders who are detected in the first level detection zones.

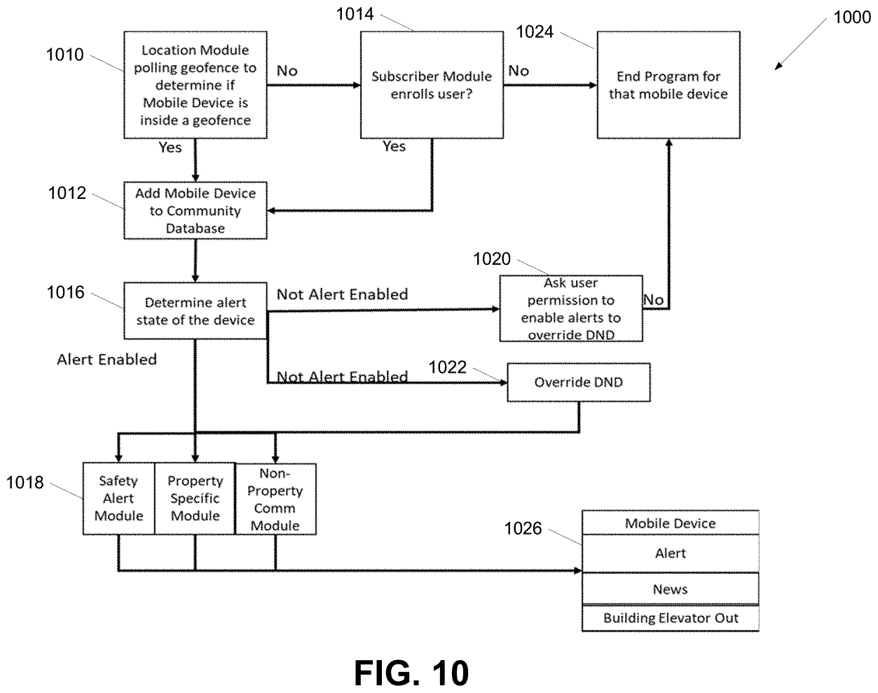

FIG. 10 illustrates a process for providing an emergency alerts to members of a community in accordance with one or more aspects described herein. Some or all of the steps of process 1000 may be performed using any of the computing devices and/or combination thereof described herein. In a variety of embodiments, some or all of the steps described below may be combined and/or divided into sub-steps as appropriate.

At step 1010, it can be determined if a computing device is located within a particular region. For example, an emergency alert server system, using a geofencing and/or GPS systems, can determine whether a computing device associated with a particular user is physically present in a geographic region or area or range (e.g. In a building or on a property) based upon the physical location of the computing device. In several embodiments, the physical location of the computing device can be determined based on a GPS location augmented using one or more beacons located in the geographic region. At step 1012, if the user's computing device is determined to be on the property, the user's computing device can be automatically added to a community database. In several embodiments, the computing device can be added to the community database by the emergency alert server system. At step 1014, in cases where the user's computing device is determined not to be physically present on the property (e.g. not detected by proximity sensors), the user can be provided with the option of voluntarily subscribing to join the community (e.g. enter the user's computing device into the community database) by providing a subscription request on the computing device. In this way, interested users (e.g. building tenants who are away at work, persons working at different job sites, and the like) can be kept informed of developments and alerts with regard to a particular property community even when they are physically away from that property. If the computing device does not subscribe to the community, the process can end at step 1024.

At step 1016, the alert state of each of the subscribed computing devices can be determined. This can be accomplished by sending a signal to the computing device to determine if the computing device's “silent” or “do not disturb” setting is on. If the computing device setting is alert-enabled (e.g. the “do not disturb” or “silent” function is not turned on), then the computing device is ready to receive alert messages. However, in those cases where the computing device is not alert-enabled (e.g. the “do not disturb” or “silent” function is turned on), then one of two options is possible. First, at step 1020, a message can be sent to the user asking if the alert setting can be switched to alert-enabled. Should the user agree and grant permission, then the alert enabled setting is enabled (e.g. the “do not disturb” or “silent” function is overridden). If the user does not agree to set the computing device to an alert-enabled state, the process can end at step 1024. Second, at step 1022, the system may instead proceed directly to automatically override the “do not disturb” or “silent” function, thereby enabling the computing device to receive alerts and communications from system.

At step 1018, a variety of messages can be sent using the emergency alert server system. In addition to sending emergency alerts through the emergency alert module, the emergency alert server system also can send property-specific (or interest group-specific) messages using the property specific module and non-property-specific messages (e.g. Messages appealing to more than one property or interest group-specific group) using the non-property communication module. In various embodiments of the system, the property-specific messages sent by the property specific module and the non-property-specific messages sent by the non-property communication module may be sent with the “do not disturb” or “silent” function (e.g. an alert-inhibiting setting) of the computing device overridden and turned off. However, the more likely desired setting may be to have the property-specific messages sent by the property specific module and non-property-specific messages sent by the non-property communication module are subject to the “do not disturb” or “silent” settings of the computing device. In such a case, the emergency alert system can be configured such that only emergency alert messages will override the “do not disturb” or “silent” settings of the computing device, while other messages (e.g. Building advertisements and/or messages) will not override the “do not disturb” or “silent” settings. The settings used can optionally be set by members of the community themselves, by the manager or administrator of the community, or both. This is desirable such that users/community members receive emergency alerts such as “fire” or “active shooter in the building” without such messages being silenced, but can block, silence, and/or turn off messages like “lunch specials in the building's café.” These various alerts can be provided via the computing device in step 1026. The alerts may be provided using any audible, visual, and/or haptic notifications indicated in the alert.

The emergency alert server system can communicate with communities of users determined to be located in a particular geographic region. The alerts provided by the emergency alert server system can override any alert-inhibiting state of a computing device to deliver audio, visual, and/or haptic notifications in emergency situations as described herein. Emergency alert server systems can alert multiple communities based on, but not limited to, their role in the community, the alert state, and/or their geolocation. Alert states generated for one community can cause additional alerts to be generated for members of secondary communities located in such a manner that the alert conditions may affect the secondary community. If additional conditions occur, the provided alerts can be modified and/or retransmitted to the various communities. The emergency alert server system can provide these updated alerts to the first and second communities.

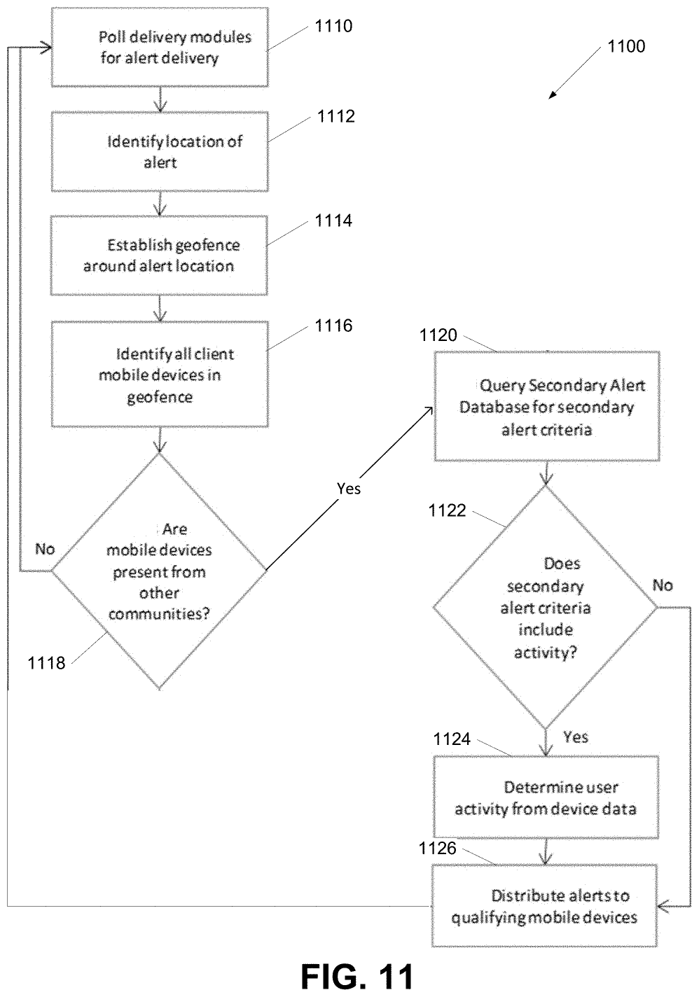

FIG. 11 depicts a flow chart for cross routing of alerts according to one or more aspects of the disclosure. Some or all of the steps of process 1100 may be performed using any of the computing devices and/or combination thereof described herein. In a variety of embodiments, some or all of the steps described below may be combined and/or divided into sub-steps as appropriate.

At step 1110, an emergency alert server system can monitor for the delivery of alerts to computing devices in the community and/or responses to the delivered alerts. For example, an intruder can be detected in a first detection zone and a corresponding alert can be transmitted to supervisors of a primary community tasked with patrolling a border associated with the first detection zone. When the intruder is detected in a second detection zone, an alert can be sent to one or more agent users of the community indicating an alert area in which the agents should search for the intruder. At step 1112, the emergency alert server system can identify the location of the alert. At step 1114, the emergency alert server system can establish a geofenced region, such as an alert area. For example, the alert area can be defined as a region the alert is located in, such as a school campus, and/or it may be based on common geographic boundaries, such as towns, neighborhoods, and the like.

At step 1116, the emergency alert server system can identify one or more users located within the alert area that belongs to communities other than the primary community to which the alert is related. For example, a police department can be alerted when an intruder is detected so that the police department can begin preparing paperwork and/or a holding area for the intruder. At step 1118, the emergency alert server system can determine if any of the computing devices within the alert areas belong to communities other than the primary community to which the alert is related. For example, when an intruder is detected, the primary community can include border patrol agents and the secondary community can include the local police department. If none of the computing devices are related to the primary community, the process can return to step 1110 or end. If there are computing devices in the alert area that are not members of the primary community, the emergency alert server system can query a secondary alert database for secondary alert criteria at step 1120. The secondary alert database can include alert conditions, severity tiers, which communities should be notified for particular alerts, which roles inside of that community should be notified, what the alert message and/or audio/visual/haptic feedback should be, and the like. At step 1122, the emergency alert server system can determine if a secondary alert has an activity restriction on its delivery. For example, an out of community user who is within a few blocks of the alert area can be notified, but that same user who is located on the other side of a geographic barrier may not be alerted as the user would not be able to reach the alert area. If there are activity restrictions at step 1122, the process can proceed to step 1124. If the alert does not have activity restrictions at step 1122, the process can proceed to step 1126. At step 1124, the emergency alert server system can determine user activity based on data obtained from the computing device. For example, if the computing device is connected to a vehicle, the emergency alert server system can determine that the user is driving and the user may be capable of traveling to alert areas further away from their current location than users who are on foot. At step 1126, the emergency alert server system can transmit the alerts to the identified computing devices in the identified communities as described herein.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied, in whole or in part, in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A computer-implemented method, comprising:
obtaining an indication of an intruder in a first detection zone;
determining a current location of the intruder;
determining a direction of travel of the intruder;
generating an alert area comprising a geographic location in the direction of travel of the intruder;
identifying at least one user associated with the alert area;
generating an alert indicating the current location of the intruder, the direction of travel of the intruder, the alert area, and at least one notification; and
transmitting the alert to at least one computing device associated with the at least one user, wherein the alert causes a computing device to provide the at least one notification irrespective of any alert-inhibiting state of the computing device.

2. The computer-implemented method of claim 1, further comprising determining the direction of travel of the intruder by:
obtaining an indication of the intruder in a second detection zone distinct from the first detection zone;
determining a relative location of the second detection zone to the first detection zone; and
determining the direction of travel based on the relative location of the second detection zone to the first detection zone.

3. The computer-implemented method of claim 2, further comprising:
obtaining a first time when the intruder is located in the first detection zone;
obtaining a second time when the intruder is located in the second detection zone;
calculating an elapsed time based on a difference between the second time and the first time;
calculating a distance traveled based on a size of the first detection zone and a size of the second detection zone;
calculating a speed of the intruder based on the elapsed time and the distance traveled; and
including the calculated speed in the generated alert.

4. The computer-implemented method of claim 3, further comprising generating the alert area based on the calculated speed.

5. The computer-implemented method of claim 1, further comprising:
obtaining an indication that the intruder has entered a second detection zone, wherein the first detection zone is located before a border and the second detection zone is located beyond the border;
generating a second alert to a community of users associated with the border; and
transmitting the second alert to at least one computing device associated with the community of users associated with the border.

6. The computer-implemented method of claim 1, wherein the indication that the intruder is located in the first detection zone comprises sensor data captured using at least one sensor selected from the group consisting of cameras, motion detectors, pressure sensors, microphones, and infrared sensors.

7. The computer-implemented method of claim 1, wherein the at least one notification is selected from the group consisting of an audible notification, a visual notification, and a haptic notification.

8. A computing device, comprising:
a processor; and
a memory in communication with the processor and storing instructions that, when read by the processor, cause the computing device to:
obtain an indication of an intruder in a first detection zone;
determine a current location of the intruder;
determine a direction of travel of the intruder;
generate an alert area comprising a geographic location in the direction of travel of the intruder;
identify at least one user associated with the alert area;
generate an alert indicating the current location of the intruder, the direction of travel of the intruder, the alert area, and at least one notification; and
transmit the alert to at least one computing device associated with the at least one user, wherein the alert causes a computing device to provide the at least one notification irrespective of any alert-inhibiting state of the computing device.

9. The computing device of claim 8, wherein the instructions, when read by the processor, further cause the computing device to determine the direction of travel of the intruder by:
obtaining an indication of the intruder in a second detection zone distinct from the first detection zone;
determining a relative location of the second detection zone to the first detection zone; and
determining the direction of travel based on the relative location of the second detection zone to the first detection zone.

10. The computing device of claim 9, wherein the instructions, when read by the processor, further cause the computing device to:
obtain a first time when the intruder is located in the first detection zone;
obtain a second time when the intruder is located in the second detection zone;
calculate an elapsed time based on a difference between the second time and the first time;
calculate a distance traveled based on a size of the first detection zone and a size of the second detection zone;
calculate a speed of the intruder based on the elapsed time and the distance traveled; and
include the calculated speed in the generated alert.

11. The computing device of claim 10, wherein the instructions, when read by the processor, further cause the computing device to generate the alert area based on the calculated speed.

12. The computing device of claim 8, wherein the instructions, when read by the processor, further cause the computing device to:
obtain an indication that the intruder has entered a second detection zone, wherein the first detection zone is located before a border and the second detection zone is located beyond the border;
generate a second alert to a community of users associated with the border; and
transmit the second alert to at least one computing device associated with the community of users associated with the border.

13. The computing device of claim 8, wherein the indication that the intruder is located in the first detection zone comprises sensor data captured using at least one sensor selected from the group consisting of cameras, motion detectors, pressure sensors, microphones, and infrared sensors.

14. The computing device of claim 8, wherein the at least one notification is selected from the group consisting of an audible notification, a visual notification, and a haptic notification.

15. A non-transitory machine-readable medium storing instructions that, when executed by one or more processors, cause the one or more processors to perform steps comprising:
obtaining an indication of an intruder in a first detection zone;
determining a current location of the intruder;
determining a direction of travel of the intruder;
generating an alert area comprising a geographic location in the direction of travel of the intruder;
identifying at least one user associated with the alert area;
generating an alert indicating the current location of the intruder, the direction of travel of the intruder, the alert area, and at least one notification; and
transmitting the alert to at least one computing device associated with the at least one user, wherein the alert causes a computing device to provide the at least one notification irrespective of any alert-inhibiting state of the computing device.

16. The non-transitory machine-readable medium of claim 15, wherein the instructions, when executed by one or more processors, further cause the one or more processors to determine the direction of travel of the intruder by performing steps comprising:
obtaining an indication of the intruder in a second detection zone distinct from the first detection zone;
determining a relative location of the second detection zone to the first detection zone; and
determining the direction of travel based on the relative location of the second detection zone to the first detection zone.

17. The non-transitory machine-readable medium of claim 16, wherein the instructions, when executed by one or more processors, further cause the one or more processors to perform steps comprising:
obtaining a first time when the intruder is located in the first detection zone;
obtaining a second time when the intruder is located in the second detection zone;
calculating an elapsed time based on a difference between the second time and the first time;
calculating a distance traveled based on a size of the first detection zone and a size of the second detection zone;
calculating a speed of the intruder based on the elapsed time and the distance traveled; and
including the calculated speed in the generated alert.

18. The non-transitory machine-readable medium of claim 15, wherein the instructions, when executed by one or more processors, further cause the one or more processors to perform steps comprising:
obtaining an indication that the intruder has entered a second detection zone, wherein the first detection zone is located before a border and the second detection zone is located beyond the border;
generating a second alert to a community of users associated with the border; and
transmitting the second alert to at least one computing device associated with the community of users associated with the border.

19. The non-transitory machine-readable medium of claim 15, wherein the indication that the intruder is located in the first detection zone comprises sensor data captured using at least one sensor selected from the group consisting of cameras, motion detectors, pressure sensors, microphones, and infrared sensors.

20. The non-transitory machine-readable medium of claim 15, wherein the at least one notification is selected from the group consisting of an audible notification, a visual notification, and a haptic notification.
